(19) United States
(12) Patent Application Publication
(10) Pub. No.: US 2026/0097626 A1
(43) Pub. Date: Apr. 9, 2026

(54) VENTING DEFLECTION COMPONENT COVER

(71) Applicant: FCA US LLC, Auburn Hills, MI (US)

(72) Inventors: Ian R. Williams, Auburn Hills, MI (US); Brian K. Begg, Auburn Hills, MI (US)

(21) Appl. No.: 18/910,647

(22) Filed: Oct. 9, 2024

(51) Int. Cl. B60H 1/24; B60R 13/02

(52) U.S. Cl. CPC B60H 1/248; B60R 13/02

(57) ABSTRACT

A vehicle vent deflector has a body defining a cavity with an inlet and an outlet. The body includes a peripheral flange defining the inlet. The cavity in the body is adjacent the peripheral flange. The cavity receives air flow from the inlet. The cavity is defined by a wall with a desired shape. A cutout in the wall defines the outlet that enables the air flow to pass from the cavity out to the outlet.

### FIELD

The present disclosure relates to vehicles and, more particularly, to a venting deflection component cover.

### BACKGROUND

This section provides background information related to the present disclosure which is not necessarily prior art.

In automotive vehicles, when a vehicle door shuts, pressure is created in the cabin. In order to dissipate this pressure, different vents exist to exit the air in the cabin to equalize pressure. Typically, the path of the airflow to the exterior of the vehicle occurs behind the trim panels. This occurs with the airflow uncontrolled and not directed through the vehicle. Vehicle metal, wiring, modules and other surrounding components are generally visible by the vehicle occupant through the vent openings.

Previous interior trim panels and associated trim panel brackets have not been effective in directing airflow through the vehicle nor in creating a diverter path for road noise. The concealing of the vehicle metals, wires and other components was not accomplished by previous trim panel. To facilitate the concealing of these components in the past, a fabric separator was utilized. This fabric separator restricts the flow of air and is costly. Accordingly, designers strive to improve the art.

The present disclosure provides a venting deflection component cover that controls or directs the airflow from inside of the interior cabin to vent the airflow to the vehicle exterior. The present disclosure also blocks the path of road noise from passing into the interior cabin of the vehicle from outside the vehicle. Further, the present disclosure conceals vehicle metal, wires and other surrounding components from view of the occupants inside the vehicle. Also, the present disclosure is recyclable, weighs less than previous designs and is more cost effective. The present disclosure controls the airflow direction from inside of the interior cabin towards the vent in the vehicle exterior, this vent equalizes the air pressure inside the interior cabin when someone closes one or more of the vehicle doors. The present disclosure also blocks the path of road noise from passing into the interior of the cabin of the vehicle.

### SUMMARY

This section provides a general summary of the disclosure, and is not a comprehensive disclosure of its full scope or all of its features.

According to the present disclosure, a vehicle vent deflector comprises a body with an inlet and an outlet. The body includes a peripheral flange defining the inlet. The cavity in the body is adjacent to the peripheral flange. The cavity receives airflow from the inlet. The cavity is defined by a wall with a desired shape and a cutout in the wall defining the outlet to enable airflow to pass from the cavity out to the outlet. The deflector includes securement tabs on the flange to secure the deflector to an interior trim part. The cavity is elongated and the wall has an overall elongated box shape opened at the flange. The outlet is cut out in the cavity wall eliminating a portion of the flange attached adjacent to the cutout.

According to a second object of the disclosure, an interior vehicle part for a vehicle comprising a body panel secured to the vehicle interior. The body panel includes a vent aperture to enable air from inside the vehicle to exit through the vent aperture when a door is closed to equalize air pressure in the vehicle. A vent deflector is coupled with the body panel. A vehicle vent deflector comprises a body having an inlet and an outlet. The body includes a peripheral flange defining the inlet. The cavity in the body is adjacent to the peripheral flange. The cavity receives airflow from the inlet. The cavity is defined by a wall with a desired shape and a cutout in the wall defining the outlet to enable airflow to pass from the cavity out to the outlet. The deflector includes securement tabs on the flange to secure the deflector to an interior trim part. The cavity is elongated and the wall has an overall elongated box shape opened at the flange. The outlet is cut out in the cavity wall eliminating a portion of the flange attached adjacent the cutout.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an interior part.

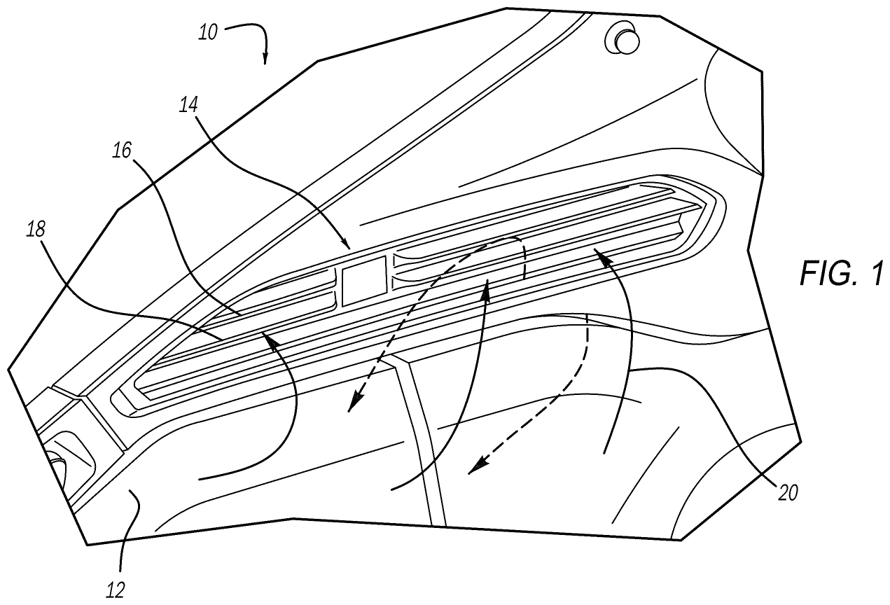

FIG. 2 is a rear perspective view of the interior part of FIG. 1.

FIG. 3 is a schematic perspective view of the deflector.

Corresponding reference numerals indicate corresponding parts throughout the several views of the drawings.

### DETAILED DESCRIPTION

Example embodiments will now be described more fully with reference to the accompanying drawings.

Turning to the figures, an interior part is illustrated and designated with the reference numeral 10. The interior part 10 is connected with the vehicle framework 12.

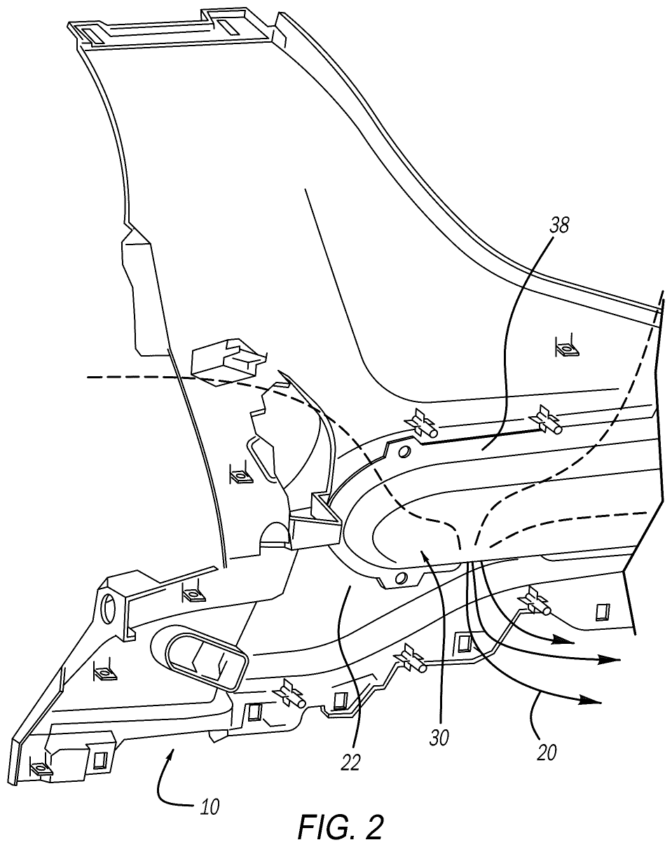

A vent 14 is formed in the interior part 10 to enable air to exit the vehicle when a vehicle door is closed to equalize the air pressure within the vehicle cabin 10. The vent 14 may have a plurality of fins 16 with apertures 18 in between the fins 16. A flow path 20 is illustrated wherein the air enters into the vent 14 and is moved to exit the vehicle. A vent deflector 30 (FIG. 2) is coupled with the interior part 10 on its exterior inner surface 22 and is positioned behind the vent 14.

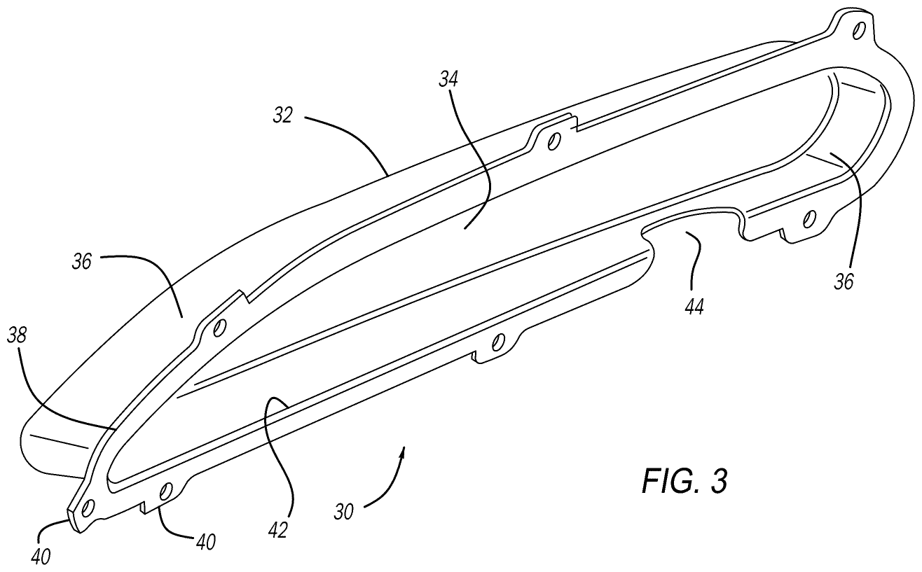

The vent deflector 30 (FIG. 3) includes a body 32 having a base 34 with a surrounding wall 36. This provides the deflector body 32 with an overall box shape. The wall 36 includes a projecting flange 38 that surrounds the wall. The wall includes a plurality of securement tabs 40 that receive fasteners to secure the deflector 30 with the interior part 10. The deflector 30 includes an inlet portion 42 and an outlet 44. The inlet is in the box body portion 32 that is adjacent to the vent 14. The outlet 44 is a cutout in the wall and flange 36, 38. The outlet 44 is adjacent to the vehicle vent to enable the air which passes into the deflector 30 to be moved out of the vehicle. Thus, the airflow enters into the body cavity and exits through the cutout 44.

The deflector 30 can be formed from a molded material. It can be a molded plastic material or a molded felt material. Additionally, it can be a molded felt and plastic material which provides superior sound deadening characteristics. Thus, the deflector 30 will control the airflow direction from inside of the interior cabin towards the vent in the vehicle exterior. The vent equalizes the air pressure inside the interior cabin when one or more doors are closed in the vehicle. Additionally, the deflector 30 locks the path of road noise from passing into the interior of the cabin of the vehicle. Thus, having a sound deadening material forming the deflector provides excellent results. Additionally, the deflector 30 conceals vehicle metal, wires and other surround components from view of the occupant inside the vehicle through the vent.

In use, air in the vehicle cabin is moved through the vent 14 of the interior part 10 into the deflector 30. The deflector 30 is secured with the interior part 10 so as to collect the air in the body cavity and move it towards the outlet 44. As it moves toward the outlet 44, the air is directed through to vent in the vehicle enabling the air to exit the vehicle to ambient. Thus, when a door is shut, the vent with the deflector 30 equalizes the pressure in the cabin by enabling the compressed air in the cabin to exit the vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle vent deflector comprising:
a body having an inlet and an outlet;
the body including a peripheral flange defining the inlet;
a cavity in the body is adjacent the peripheral flange, the cavity receives air flow from the inlet, the cavity is defined by a wall with a desired shape; and
a cutout in the wall defining the outlet enables the air flow to pass from the cavity out to the outlet.

2. The vehicle vent deflector of claim 1, including securement tabs on the flange to secure the deflector to an interior part.

3. The vehicle vent deflector of claim 1, wherein the cavity is elongated.

4. The vehicle vent deflector of claim 1, wherein the wall has an overall elongated box shape open at the flange.

5. The vehicle vent deflector of claim 1, wherein the outlet is a cutout in the cavity wall, the cutout eliminated a portion of the flange adjacent the cutout.

6. An interior part for a vehicle comprising:
a body panel, the body panel secured to the vehicle, the body panel including a vent aperture for enabling air from inside the vehicle to exit through the vent aperture when a door is closed to equalize air pressure in the vehicle;
a vent deflector coupled with the body panel;
a body having an inlet and an outlet;
the body including a peripheral flange defining the inlet;
a cavity in the body is adjacent the peripheral flange, the cavity receives air flow from the inlet, the cavity is defined by a wall with a desired shape; and
a cutout in the wall defining the outlet enables the air flow to pass from the cavity out to the outlet.

7. The interior part of claim 6, including securement tabs on the flange to secure the deflector to an interior part.

8. The interior part of claim 6, wherein the cavity is elongated.

9. The interior part of claim 6, wherein the wall has an overall elongated box shape open at the flange.

10. The interior part of claim 6, wherein the outlet is a cutout in the cavity wall, the cutout eliminated a portion of the flange adjacent the cutout.
